(19) United States
(12) Patent Application Publication
(10) Pub. No.: US 2006/0038782 A1
(43) Pub. Date: Feb. 23, 2006

(54) Computer mouse with top flip cover and flip mechanism

(76) Inventor: Heng Ju Lo, Taipei (TW)

Correspondence Address: Han-Yi Lee;BAYSHORE PATENT GROUP, LLC., 520 Chantecler Dr., Fremont, CA, 94539, US

(21) Appl. No.: 11/068,377

(22) Filed: Feb. 28, 2005

(30) Foreign Application Priority Data
Aug. 20, 2004 (TW) 093213285

(51) Int. Cl. G09G 5/08

(52) U.S. Cl. 345/163

(57) ABSTRACT

A computer mouse comprises a main body, a top flip cover, a battery compartment, and flip mechanism. The top flip cover is with shape similar to the top portion of the main body and arranged upon the top portion thereof. A battery compartment formed within the top portion of the main body and arranged beneath the top flip cover. The flip mechanism is engaged to hold the rear portion of the top flip cover with the rear portion of said main body, engaging the top flip cover to overlay the top portion of the main body in a releasably positioned manner, therefore the top flip cover is positioned to overlay the top portion of the main body of the mouse. With the engagement of the flip mechanism, the top flip cover can pop backward to a predetermined angel and expose the battery compartment.

### BACKGROUND OF THE INVENTION

For some of the conventional computer mouses, the batteries are often stored in a battery chamber with a battery cover. The battery cover is generally arranged on the base housing of the mouse and can be opened by pressing a knob. To replace the exhausted batteries, the users have to turn the computer mouse in an upside down position and slide the top cover. After replacing the batteries, the users have to close the battery cover and then reposition the mouse for further use. Such trivial battery replacement procedures are the major drawback for the conventional computer mouses.

For other conventional computer mouses, the batteries stored in a battery chamber with a battery cover is generally arranged upon the upper housing of the mouse. To replace the exhausted batteries, the users have to open the battery cover by a latch and then detach the battery cover. Such trivial battery replacement procedures are another major drawback for the conventional computer mouses.

It is the object of the present invention to provide an improved computer mouse which has a top flip cover with shape similar to the top housing of the mouse and arranged upon the top housing and a battery compartment beneath the cover. Therefore, when the flip cover pops backward it exposes the battery compartment, making it easy to replace the battery for the general users.

### SUMMARY OF THE INVENTION

The present invention provides a computer mouse which has a top flip cover that can pop backward to a predetermined angel and expose the battery compartment. The top flip cover can serve as the functions of the knob and a cover for the battery compartment.

In one embodiment, the top flip cover for the mouse serves as a cover for the battery compartment, providing a mouse that is free of battery cover. Thus makes it easy for a user to replace the batteries.

In a preferred embodiment, the computer mouse contains a main body and a top flip cover that can pop backward and expose the battery compartment. The top flip cover is with shape similar to the top portion of the main body and arranged upon the top housing. A battery compartment is formed within the top portion of the main body and is arranged beneath the top flip cover. The mouse further contains a flip mechanism. The rear portion of the top flip cover can be joined with the rear portion of the main body by the engagement of the flip mechanism, therefore the top flip cover is positioned to overlay the top portion of the main body of the mouse. Furthermore with the engagement of the flip mechanism, the top flip cover can pop backward to a predetermined angel. This simplifies the steps of battery replacement.

For a further understanding of the nature and advance of the invention, reference should be made to the following description in conjunction with the accompany drawings.

### BRIEF DESCRIPTION OF THE DRAWING

The drawings of preferred embodiments of this invention are described in following details to enable better understanding.

FIG. 1 is a perspective view of the invention of a mouse according to the present invention;

FIG. 2 is an exploded view of FIG. 1 illustrating the release of the top flip cover;

FIG. 3 is an exploded view of FIG. 1 with the top flip cover moved;

FIG. 4 is a perspective view of the invention of a mouse according to the present invention;

FIG. 5 is an exploded view of FIG. 4 illustrating the release of the top flip cover;

FIG. 6 is an exploded view of FIG. 4 with the top flip cover moved;

FIG. 7 is an exploded view of FIG. 4.

### DETAIL DESCRIPTION OF PREFERRED EMBODIMENT

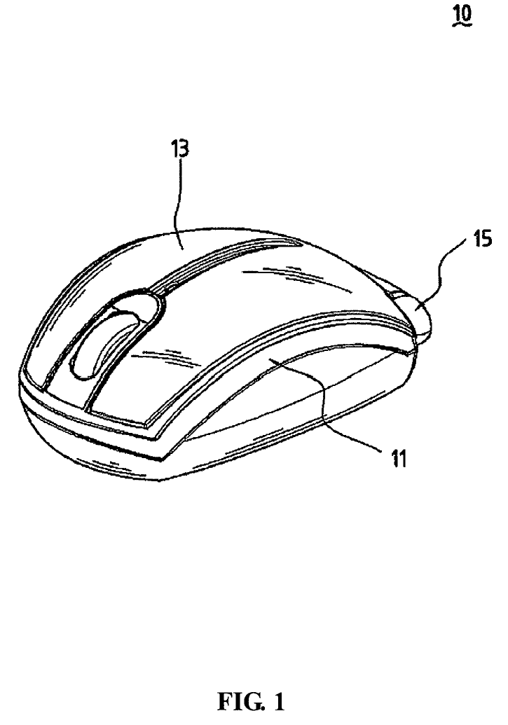

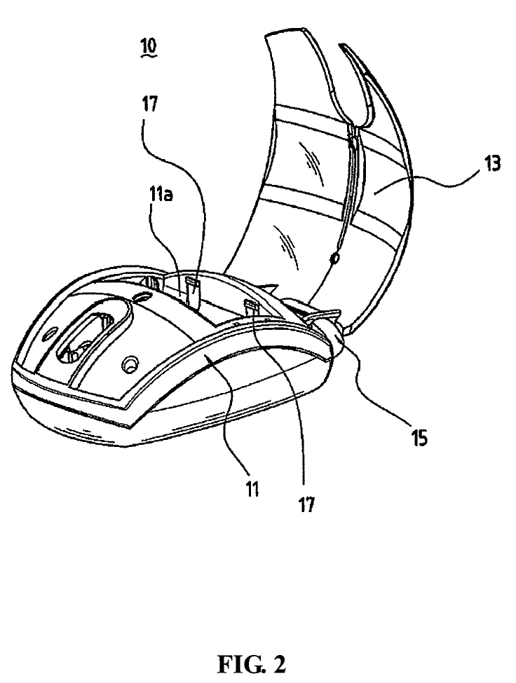

FIG. 1 illustrates a computer mouse 10 according to the first embodiment of the present invention. FIG. 2 illustrates an exploded view of FIG. 1 illustrating the release of the top flip cover 13. The computer mouse 10 comprises a main body 11, a top flip cover 13 with shape similar to the top portion of main body 10 and arranged upon the top portion thereof, a battery compartment 11a formed within the top portion of the main body 10 and arranged beneath the top flip cover 13, and a flip mechanism 15 mounted on the rear portion of the main body 10. The top flip cover 13 is held in place by a flip mechanism 15. To replace the exhausted batteries, the user can gently press the flip mechanism 15, the flip cover 13 will pop backward to a predetermined angel to expose the battery compartment 11a as shown in FIG. 2. After the battery replacement, the user then slid the top cover 13 backwards in the same direction to cover the top portion of the main body 11.

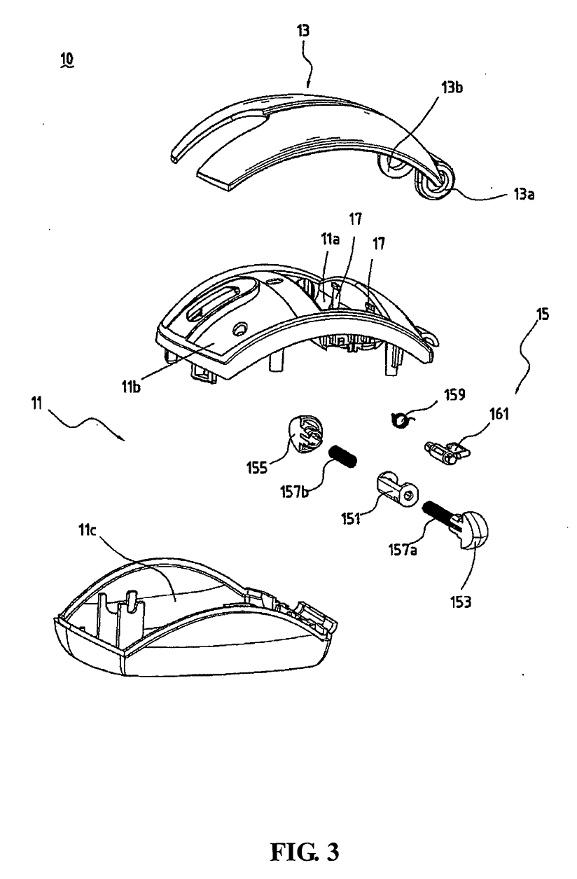

FIG. 3 is an exploded view illustrating the first embodiment of the present invention. As shown in FIG. 3, the main body 11 of the computer mouse 10 comprises an upper housing 11b and a lower housing 11c. The top housing 11b can be locked on the lower housing 11c with a screw. The top flip cover 13 is with shape similar to the top portion of the main body 11 and arranged upon the top portion thereof. A battery compartment 11a is formed within the top portion of the main body 11 and is arranged beneath the top flip cover 13. In one embodiment, the top flip cover 13 for the computer mouse 10 serves as a cover for the battery compartment 11a, providing a mouse that is free of battery cover.

The rear portion of the top flip cover 13 is mounted on the rear portion of the main body 11 of the computer mouse 10. In a preferred embodiment, the top flip cover 13 is mounted each with the rear portion of the upper housing 11b and the rear portion of the lower housing 11c of the main body 11.

One pair of a right earlobe 13a and a corresponding left earlobe 13b is each located at the rear two sides of the top flip cover 13. The pair of the right and ear earlobes 13a & 13b is connected with the flip mechanism 15. In another embodiment, the pair of a right earlobe 13a and an opposite left earlobe 13b is each located at the front two sides of the top flip cover 13. The pair of the right and ear earlobes 13a & 13b is engaged with the flip mechanism 15.

As shown in FIG. 3, the mouse further contains a flip mechanism 15 that comprises one pair of right ear cover 153 and an opposite left ear cover 155. The rear portion of the top flip cover 13 can be joined with the rear portion of the main body 11 of the computer mouse 10 by the engagement of the flip mechanism 15, therefore the top flip cover 13 is positioned to overlay the top portion of the main body 11 of the mouse 10. As shown in FIG. 2, with the engagement of the flip mechanism 15, the top flip cover 13 can pop backward to a predetermined angel. In a preferred embodiment, the top flip cover 13 can pop backward to about 90 degrees. When replacing the exhausted batteries, the user needs only to press the middle portion of the ear covers 153 &155 of the flip mechanism 15. With the engagement of the flip mechanism 15, the top flip cover 13 can pop backward to about 90 degrees. After the battery replacement, the user then slide the top flip cover 13 backwards in the same direction to cover top portion of the main body 11 of the mouse 10.

As shown in FIG. 3, the flip mechanism 15 comprises a joint block 151, a pair of right-ear cover 153 and an opposite left-ear cover 155, springs 157a and 157b, a twist spring means 159, and a positioning block 161. A more detailed description of these components will be illustrated in the subsequent paragraph.

The spring 157a is inserted into the protruding portion of the T-shaped right-ear cover 153. The left side of the right-ear cover containing the spring 157a first penetrates through the right earlobe 13a. The combined components then penetrate through the right side of the joint block 151 and are fixed thereof. The spring 157b is inserted into the protruding portion of the T-shaped left-ear cover 155. The right side of the left-ear cover containing the spring 157b first penetrates through the left earlobe 13b. The combined components then penetrate through the left side of the joint block 151 and are fixed thereof. The twist spring means 159 can provide spring force for popping out the top flip cover 13. One side of the twist spring means 161 penetrates through the positioning block 161 while the opposite side of the twist spring means 161 is biased against the top flip cover 13. The positioning block 161 is functioned to limit the popping angel of the top flip cover 13, for example, to a degree which is no less than 45 degrees but no more than 180 degrees. By joining within the joint block 151, the positioning block 161 can rotate together with the joint block 151 and the top flip cover 13.

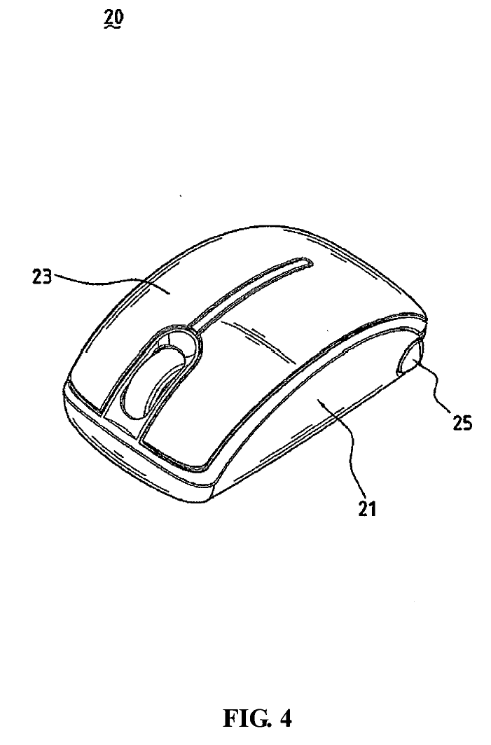

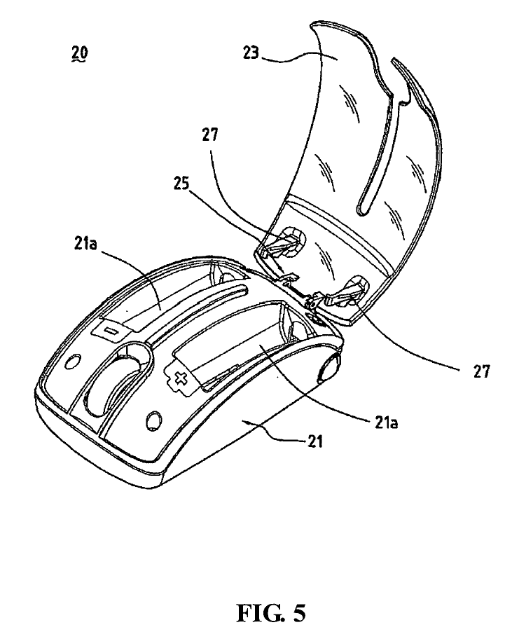

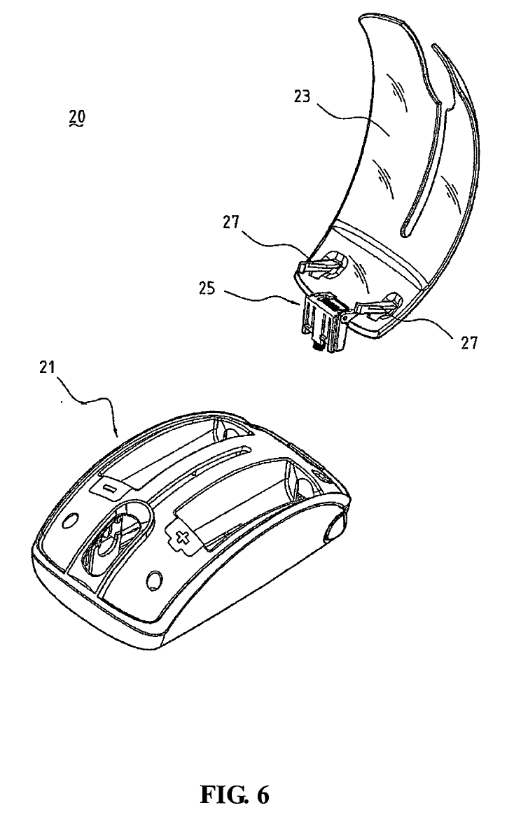

FIG. 4 is a perspective view of the invention of a computer mouse according to the second embodiment of the present invention. FIG. 5 is an exploded view of the second embodiment of the present invention illustrating the release of the top flip cover 13. FIG. 6 is an exploded view of the second embodiment of the present invention with a removed top flip cover 13. As shown in FIG. 4 & FIG. 5, the computer mouse 20 comprises a main body 21, a top flip cover 23 with shape similar to the top portion of main body 20 and arranged upon the top portion thereof, the battery compartment 21a formed within the top portion of the main body 20 and arranged beneath the top flip cover 23, and a flip mechanism 25 mounted on the rear portion of the main body 20. The top flip cover 23 is held in place by a flip mechanism 25. To replace the exhausted batteries, the user can gently press the flip mechanism 25, the flip cover 23 will pop backward to a predetermined angel to expose the battery compartment 21a as shown in FIG. 5. After the battery replacement, the user then slid the top cover 23 backwards in the same direction to cover the top portion of the main body 21. As shown in FIG. 6, in another embodiment of the present invention, the user can detach the top flip cover 23 after it popped backward.

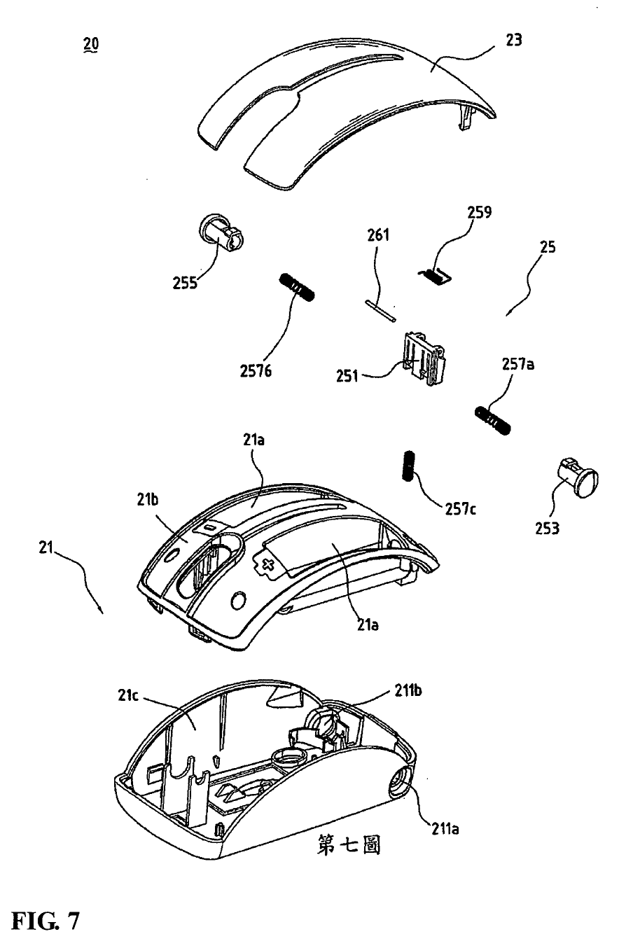

FIG. 7 is an exploded view illustrating the second embodiment of the present invention. As shown in FIG. 7, the main body 21 of the computer mouse 20 comprises an upper housing 21b and a lower housing 21c. The top housing 21b can be locked on the lower housing 21c with a screw. The top flip cover 23 is with shape similar to the top portion of the main body 21 and arranged upon the top portion thereof. A battery compartment 21a is formed within the top portion of the main body 21 and is arranged beneath the top flip cover 23. In one embodiment, the top flip cover 23 for the computer mouse 20 serves as a cover for the battery compartment 21a, providing a mouse that is free of battery cover.

The rear portion of the top flip cover 23 is mounted on the rear portion of the main body 21 of the computer mouse 20. In a preferred embodiment, the top flip cover 23 is mounted each with the rear portion of the upper housing 21b and the rear portion of the lower housing 21c of the main body 21.

One pair of a right earlobe 211a and a corresponding left earlobe 211b is each located at the rear two sides of the lower housing 21c. The pair of the right and ear earlobes 211a & 211b is connected with the flip mechanism 25.

As shown in FIG. 7, the mouse further contains a flip mechanism 25 that comprises one pair of right ear cover 253 and an opposite left ear cover 255. The rear portion of the top flip cover 23 can be joined with the rear portion of the main body 21 of the computer mouse 20 by the engagement of the flip mechanism 25, therefore the top flip cover 23 is positioned to overlay the top portion of the main body 21 of the mouse 20. As shown in FIG. 5, with the engagement of the flip mechanism 25, the top flip cover 23 can pop backward to a predetermined angel. In a preferred embodiment, the top flip cover 23 can pop backward to about 90 degrees. When replacing the exhausted batteries, the user needs only to press the middle portion of the ear covers 253 & 255 of the flip mechanism 25. With the engagement of the flip mechanism 25, the top flip cover 23 can pop backward to about 90 degrees. After the battery replacement, the user then slide the top flip cover 23 backwards in the same direction to cover top portion of the main body 21 of the mouse 20.

As shown in FIG. 7, the flip mechanism 25 comprises a joint block 251, a pair of right-ear cover 253 and an opposite left-ear cover 255, springs 257a and 257b, a twist spring means 259, and a latch 261. A more detailed description of these components will be illustrated in the subsequent paragraph.

The spring 257a is inserted into the protruding portion of the cylindrical right-ear cover 253. The left side of the right-ear cover containing the spring 257a first penetrates through the right earlobe 211a. The combined components then penetrate through the right side of the rear portion of the lower housing 21c and are fixed thereof. The spring 257b is inserted into the protruding portion of the cylindrical left-ear cover 255. The right side of the left-ear cover containing the spring 257b first penetrates through the left earlobe 211b. The combined components then penetrate through the left side of the rear portion of the lower housing 21c and are fixed thereof. The twist spring means 259 can provide spring force for popping out the top flip cover 23. One side of the twist spring means 259 penetrates through the positioning block 261 while the opposite side of the twist spring means 259 is biased against the top flip cover 23. The latch 261 is functioned to join both the top flip cover 23 and the joint block 251 which contains the springs 257c.

In another preferred embodiment of the current invention, as shown in FIG. 2, FIG. 3, FIG. 5, and FIG. 6, the mouse further contains T-shaped retaining blocks 17 & 27. The retaining blocks 17 & 27 are used to provide a locking function. In one embodiment, the T-shaped retaining blocks 17 are mounted on the upper housing 11b of the main body 11. In a second embodiment, the T-shaped retaining blocks 27 are mounted on bottom of the top flip cover 23.

The current invention of the top flip cover 13 and the top flip cover 23 of the mouses 10 & 20, respectively can further function as the mouse buttons (i.e., left and right buttons) of the mouses 10 & 20, respectively. Furthermore, the flip cover 13 & 23 serve as the covers for the battery compartment, providing a mouse that is free of battery cover.

The current invention of the mouses 10 & 20 can further be applied to the cordless mouse, including, but not limit to, the cordless optical mouse, the cordless USB mouse, the cordless PS2 mouse, the cordless mouse with scrolling ball.

The current invention of the mouses 10 & 20 have the following advantages. First, the top flip cover of the mouse can function as the mouse buttons and/or the cover for the battery compartment. Therefore it reduces the manufacturing cost of the cover of the battery compartment. The design of the top flip cover preserves the aesthetic appearance of the top of the mouse. Second, a top flip cover that can pop backward and expose the battery compartment. This simplifies the steps of battery replacement. Third, the current invention can facilitate the assembly of the mouse. It can apply to a variety of the aesthetic and color designs for the top flip cover of the mouse for the manufacturers.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A mouse, comprising:
a main body,
a top flip cover with shape similar to the top portion of said main body and arranged upon said top portion thereof,
a battery compartment formed within said top portion of said main body and arranged beneath said top flip cover; and
a flip mechanism engaging to hold the rear portion of said top flip cover with the rear portion of said main body, engaging said top flip cover to overlay said top portion of said main body in a releasably positioned manner, whereby said top flip cover can pop backward to a predetermined angel.

2. The mouse as claimed in claim 1, wherein said main body further comprising:
a upper housing having a battery compartment formed within therein; and
a lower housing mounted with said top housing.

3. The mouse as claimed in claim 1, wherein said top flip cover further comprising a pair of a right earlobe and a corresponding left earlobe located at the rear two sides of said top flip cover and said pair of earlobes connecting with said flip mechanism.

4. The mouse as claimed in claim 1, wherein said top flip cover further comprising a pair of a right earlobe and a corresponding left earlobe located at the front two sides of said top flip cover and said pair of earlobes connecting with said flip mechanism.

5. A mouse as in any one of the preceding claims, wherein said flip mechanism further comprising:
a joint block,
a right-ear cover penetrating through said right earlobe and then through the right side of said joint block and fixing on said joint block,
a left-ear cover penetrating through said left earlobe and then through the left side of said joint block and fixing on said joint block,
a set of two springs wherein said first spring engaging within said right-ear cover while said second spring engaging within said left-ear cover,
a twist springs means providing spring force for popping out said top flip cover,
a positioning block positioned within said joint block and connecting with one side of said twist spring means, wherein said positioning block is functioned to limit the popping angel of said top flip cover.

6. The mouse as claimed in claim 1, wherein one pair of a right earlobe and a corresponding left earlobe each located at the rear two sides of said lower housing of said main body and said pair of earlobes connecting with said flip mechanism.

7. The mouse as claimed in claim 5, wherein said flip mechanism further comprising:
a joint block,
a right-ear cover penetrating through said right earlobe and fixing on the right side of the rear portion of said lower housing of said main body,
a left-ear cover penetrating through said left earlobe and fixing on the left side of the rear portion of said lower housing of said main body,
a pair of two springs wherein said first spring engaging within said right-ear cover while said second spring engaging within said left-ear cover,
a spring inserted within said joint block,
a twist spring means for providing spring force for popping out said top flip cover; and
a latch inserted within said joint block and said top flip cover.

8. The mouse as claimed in claim 1, wherein said predetermined angel is no more than 180 degrees but no less than 45 degrees.

9. The mouse as claimed in claim 1, wherein said mouse further comprising the T-shaped retaining blocks having a locking function.

10. The mouse as claimed in claim 1, wherein said mouse is a cordless mouse.
